(19) United States
(12) Patent Application Publication
(10) Pub. No.: US 2019/0095170 A1
(43) Pub. Date: Mar. 28, 2019

(54) SYSTEMS AND METHODS FOR EMBEDDING OF AUDIO TONES AND CAUSING DEVICE ACTION IN RESPONSE TO AUDIO TONES

(71) Applicant: SonixIO, Inc., Los Angeles, CA (US)

(72) Inventors: Edward S Lang, Beverly Hills, CA (US); James Morrison, Sausalito, CA (US); Michael Lapinski, San Francisco, CA (US); Baram Nour-Omid, Los Angeles, CA (US)

(21) Appl. No.: 16/145,163

(22) Filed: Sep. 27, 2018

Related U.S. Application Data
(60) Provisional application No. 62/564,180, filed on Sep. 27, 2017.

(51) Int. Cl. G06F 3/16; G06F 9/44; G10K 15/04; H04N 21/454; G06F 21/31

(52) U.S. Cl. CPC G06F 3/167; G06F 9/44; G06F 21/31; H04N 21/454; G10K 15/04

(57) ABSTRACT

The present disclosure relates to systems and methods for embedding audio tones within content to cause one or more device actions. For example, systems of the present disclosure may allow for decoding of audio tones, applying one or more policies before authorizing device actions caused by audio tones, automatic monitoring for embedded audio tones, and automatic embedding of audio tones in content.

### CROSS-REFERENCE TO RELATED APPLICATIONS

The present application claims priority to U.S. Provisional Application No. 62/564,180, filed Sep. 27, 2017, which is incorporated herein by reference.

### TECHNICAL FIELD

The present disclosure relates generally to the field of audio tones. More specifically, and without limitation, this disclosure relates to systems and methods for embedding audio tones for causing device actions.

### BACKGROUND

Embedded content often goes unrecognized by consumers of content. For example, a consumer device may only recognize particular content. For example, the Shazam® application only recognizes content registered with Shazam® in advance. Furthermore, a consumer device generally must be manually activated in response to particular content. For example, the Shazam® application must be opened, and the microphone manually activated in order to recognize particular content.

Moreover, such content must generally be embedded in advance. For example, a maker of a television program, commercial, or the like must register particular audio signatures, that are integrally embedded with audio of the content, with Shazam® in order to allow broadcasted content to trigger the Shazam® application.

### SUMMARY

In view of the foregoing, embodiments of the present disclosure describe systems and methods for providing embedding of audio tones that trigger device actions within content. The provided systems may allow for use of a generalized development environment for creation of tones that trigger device actions. Accordingly, the systems provided herein may eliminate manual steps required to provide embedded content that triggers device responses and may increase the flexibility in doing so.

Moreover, providing flexibility for triggered device actions may risk inappropriate content being automatically delivered, such as pornography to underage individuals. To solve this problem with conventional systems, the provided systems may apply one or more policies on a server delivering the content such that the content is denied when a consumer's device is not compliant with the one or more policies.

Embodiments of the present disclosure may further allow for on-demand embedding of such content within content for broadcast or other delivery to one or more consumer devices. The provided systems may thus eliminate manual steps required to embed content that triggers device responses and may increase the flexibility in doing so.

Embodiments of the present disclosure may further allow for automatic monitoring for embedded content without continual powering of a microphone. The provided systems may thus provide greater power efficiency of consumer devices with increased the flexibility of those device in responding to embedded content.

In one embodiment, the present disclosure describes a system for providing decoding of audio tones. The system may comprise at least one memory storing instructions and at least one processor configured to execute the instructions to perform operations. The operations may comprise receiving, from a user device, a digital representation of a recorded audio signal; determining an identifier of the audio signal; based on the identifier, retrieving a database linking one or more audio codes to one or more possible device actions; decoding the digital representation to obtain at least one audio code embedded therein; using the retrieved database, mapping the at least one audio code to one or more device actions; and transmitting one or more application programming interface (API) calls to the user device, the one or more API calls corresponding to the one or more device actions, as retrieved from the database.

In one embodiment, the present disclosure describes a system for providing decoding of audio tones. The system may comprise at least one memory storing instructions and at least one processor configured to execute the instructions to perform operations. The operations may comprise receiving, from a user device, a digital representation of a recorded audio signal; receiving, from a user device, information associated with the user device; decoding the digital representation to obtain at least one audio code embedded therein; using at least one database, mapping the at least one audio code to one or more device actions; retrieving at least one policy associated with the one or more device actions; verifying the received information against the at least one policy; when the received information is verified: transmitting one or more application programming interface (API) calls to the user device, the one or more API calls corresponding to the one or more device actions; and when the received information is not verified: transmitting a denial message to the user device.

In one embodiment, the present disclosure describes a system for providing automatic monitoring for embedded audio tones. The system may comprise at least one memory storing instructions and at least one processor configured to execute the instructions to perform operations. The operations may comprise receiving a location associated with a user device; transmitting the location to a remote server; receiving, from the remote server, an indication that the location is within a predefined geographic area; in response to the indication, activating an audio sensor of the user device; receiving, using the audio sensor of the user device, a digital representation of an audio signal captured at or near the location; transmitting at least a portion of the digital representation to the remote server; and receiving, in response to the transmitted portion, one or more application programming interface (API) calls causing the user device to perform one or more functions.

In one embodiment, the present disclosure describes a system for providing on-demand monitoring for embedded audio tones. The system may comprise at least one memory storing instructions and at least one processor configured to execute the instructions to perform operations. The operations may comprise activating an audio sensor of the user device; receiving, using the audio sensor of the user device, a digital representation of an audio signal; determining whether the digital representation includes at least one audio tone corresponding to a keep alive tone; when the digital representation is determined to include the at least one audio tone: maintain the audio sensor in the activated state; and when the digital representation is determined not to include the at least one audio tone: deactivating the audio sensor of the user device.

In one embodiment, the present disclosure describes a system for automatic embedding of audio tones in content. The system may comprise at least one memory storing instructions and at least one processor configured to execute the instructions to perform operations. The operations may comprise receiving a schedule mapping time stamps of content to one or more audio tones; distributing, using at least one of a speaker, a signal transmitter, or a network interface controller, the content; and during distribution and at the time stamps, embedding the one or more audio tones on audio of the content, the one or more audio tones causing a consumption device to perform one or more actions.

In some embodiments, the present disclose describes non-transitory, computer-readable media for causing one or more processors to execute methods consistent with the present disclosure.

It is to be understood that the foregoing general description and the following detailed description are example and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the principles disclosed herein. In the drawings:

FIG. 1 is a graphical representation of embedded audio within audio of content, according to an example embodiment of the present disclosure.

FIG. 2 is a block diagram of a system for embedding of audio tones by a content creator and use of the embedded audio tones by a content consumer, according to an example embodiment of the present disclosure.

FIG. 3 is a block diagram of an example exchange between a consumer device and a remote sever for delivery of policy-protected content in response to embedded audio tones, according to an example embodiment of the present disclosure.

FIG. 4 is a flowchart of example policies used to protect content triggered by embedded audio tones, according to an example embodiment of the present disclosure.

FIG. 5 is a block diagram of an example on-demand embedding of audio tones within content, according to an example embodiment of the present disclosure.

FIG. 6 is a block diagram of an example on-demand activation of a microphone of a consumption device using geofencing, according to an example embodiment of the present disclosure.

FIG. 7 is a block diagram of an example on-demand activation of a microphone of a consumption device using a keep alive audio tone, according to an example embodiment of the present disclosure.

FIG. 8 is a block diagram of an example on-demand activation of a microphone of a consumption device using a networked activation signal, according to an example embodiment of the present disclosure.

FIG. 9 is a block diagram of an example server with which the systems, methods, and apparatuses of the present disclosure may be implemented.

FIG. 10A is a block diagram of an example consumption device with which the systems, methods, and apparatuses of the present disclosure may be implemented.

FIG. 10B is a side view of the example consumption device of FIG. 10A.

### DETAILED DESCRIPTION

The disclosed embodiments relate to systems and methods for embedding audio tones within content that trigger device actions of a consumption device. Embodiments of the present disclosure may be implemented using a general-purpose computer. Alternatively, a special-purpose computer may be built according to embodiments of the present disclosure using suitable logic elements.

Advantageously, disclosed embodiments may solve the technical problem of providing embedded audio tones with greater flexibility without providing inappropriate content. Moreover, disclosed embodiments may solve the technical problem of automating responses to the embedded audio tones without draining power by continually powering a microphone of a consumption device.

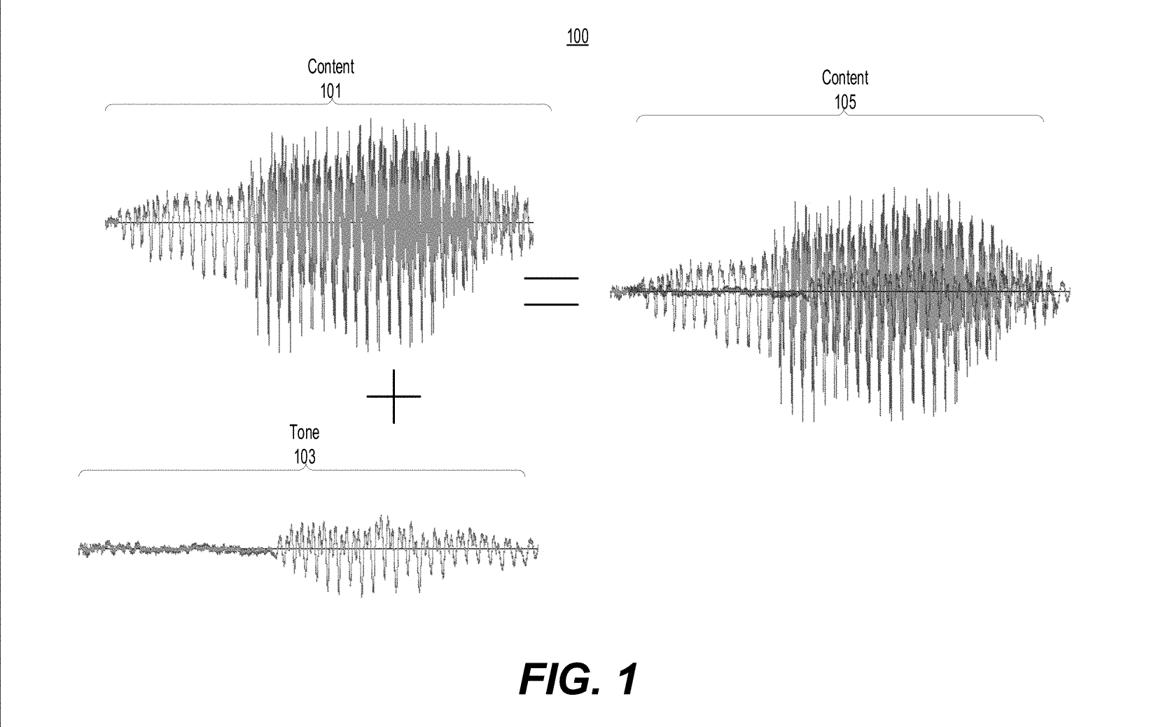

FIG. 1 depicts a block diagram of an example 100 of embedding an audio tone 103 in content audio 101. For example, as shown in FIG. 1, audio tone 103 may be embedded within content audio 101 by combining digital representations of content audio 101 and audio tone 103, simultaneous instruction of an audio speaker to produce sound waves corresponding to content audio 101 and audio tone 103 even though content audio 101 and audio tone 103 have separate digital representations, instruction of at least one audio speaker to produce sound waves corresponding to content audio 101 simultaneous with instruction of at least one other audio speaker to produce sound waves corresponding to audio tone 103, or the like. In any of these examples, content 105 may be generated, whether in digital representation and/or in sound waves, by a combination of content audio 101 with audio tone 103.

Audio tone 103 may be embedded within content audio 101 using at least one of phase-shift keying (PSK) or frequency-division multiplexing (FDM). Additionally or alternatively, audio tone 103 may be embedded within content audio 101 using at least one of differential phase-shift keying (DPSK) or orthogonal frequency-division multiplexing (OFDM). Additionally or alternatively, audio tone 103 may be embedded within content audio 101 as Morse code.

Audio tone 103 may comprise an ultrasonic, a subsonic, or an audible tone. In some embodiments, audio tone 103 may have (and/or may be adjusted to have) a gain between 0.1 and 0.5 decibels (dBs) relative to content audio 101. The relative gain may be determined with respect to one or more maxima, one or more minima, an average, a median, or other measure of content audio 101 and of audio tone 103 that are comparable.

Embodiments of the present disclosure may use an embedded audio tone such as audio tone 103 to trigger one or more actions by a user device. For example, the actions may include at least one of displaying visual content, playing audio content, opening a hyperlink, performing a financial transaction, or transmitting information associated with a user of the user device to a remote server. Accordingly, the user device may display a still image or video on a screen of the user device in response to perceiving audio tone 103; may play a song, podcast, or the like in response to perceiving audio tone 103, may open a hyperlink, e.g., using a web browser application, in response to perceiving audio tone 103; may perform a financial transaction using a bank application, a personal payment application, or the like executed by the user device in response to perceiving audio tone 103; may transmit information, such as demographic information, responses to one or more survey questions, or other information associated with the user to a remote server in response to perceiving audio tone 103; or the like. In some embodiments, the remote server may comprise the same system providing the actions (e.g., through one or more application programming interface (API) calls) to the user device.

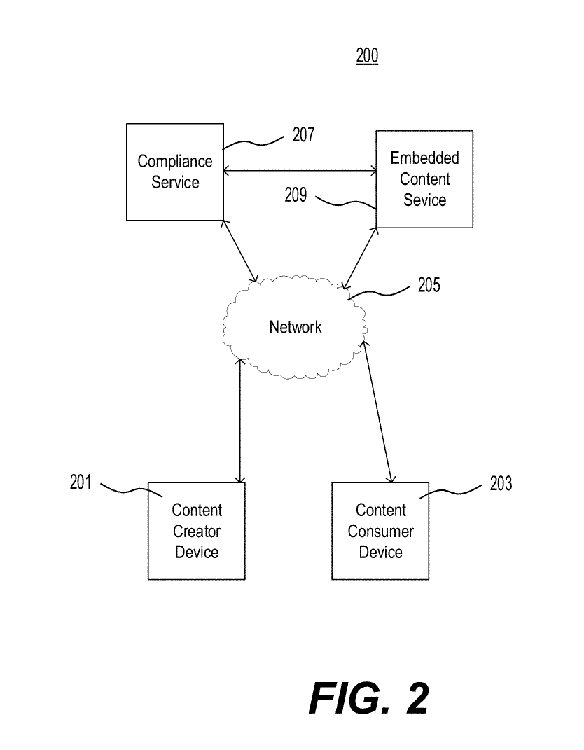

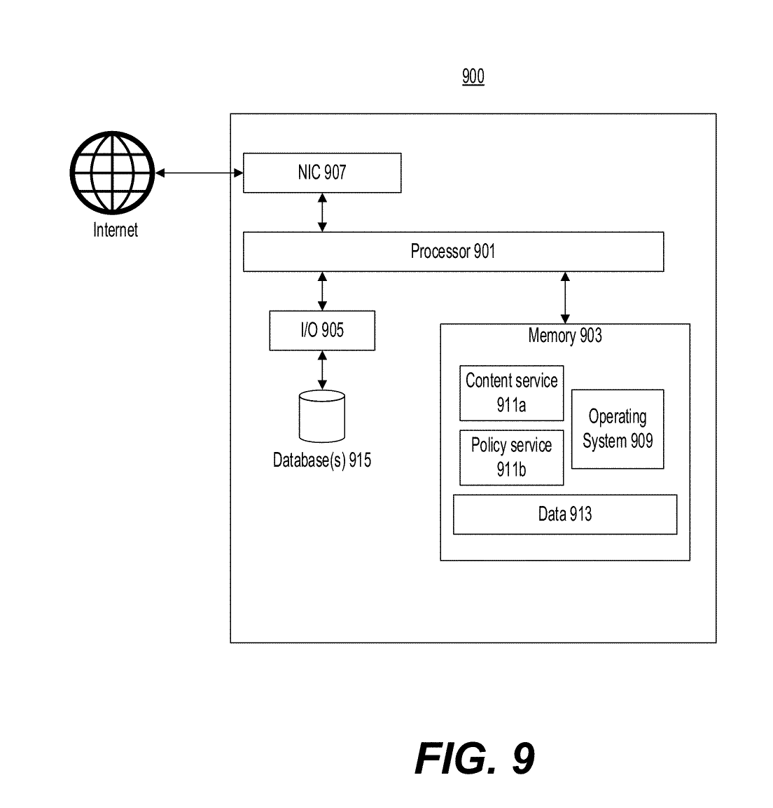

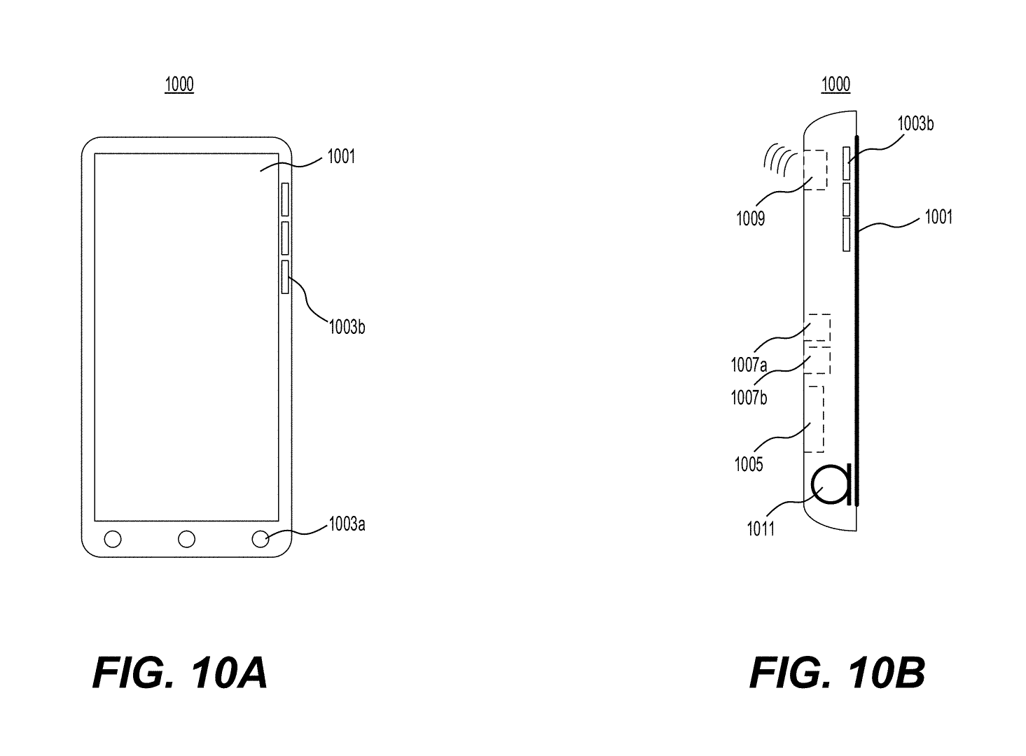

FIG. 2 block diagram of an exemplary system 200 for embedding of audio tones by a content creator device 201 and use of the embedded audio tones by a content consumer device 203. Content creator device 201 may comprise a server (e.g., server 900 of FIG. 9), a desktop computer, or the like. Content consumer device 203 may comprise a smartphone (e.g., device 1000 of FIGS. 10A and 10B), a tablet, or the like.

Embedded content service 209 (which may comprise one or more servers, e.g., server 900 of FIG. 9) may receive an audio tone for registration from content creator device 201 and store the registered audio tone in association with a corresponding audio code and an identifier of content creator device 201. Accordingly, the association may allow for lookup of registered audio tones (and/or corresponding audio codes) by the identifier and/or vice versa.

As used herein, an “audio tone” may refer to one or more sound waves and/or a digital representation thereof. An associated “audio code” may refer to a digital representation of a string, number, or other portion of data associated with a particular audio tone. The “audio code” may comprise a non-acoustic descriptor of the corresponding audio tone (e.g., an integer representing a frequency of the audio tone, an integer representing a length of the audio tone, or the like) and/or a string, number, or the like previously associated with the audio tone (e.g., by submission of the audio code with the audio tone by the content creator device 201 for registration on the embedded content server 209).

As further depicted in FIG. 2, embedded content service 209 may receive, from a user device (e.g., content consumer device 203), a digital representation of a recorded audio signal. For example, content consumer device 203 may record the audio signal using an audio sensor (e.g., a microphone) and transmit the digital representation produced by the audio sensor to embedded content service 209. In some embodiments, content consumer device 203 may pre-process the digital representation prior to transmission, e.g., by filtering out part of the recorded audio signal that content consumer device 203 identifies as not relevant. For example, content consumer device 203 may store and use one or more libraries (e.g., from a software development kit (SDK) or the like associated with embedded content service 209) to filter portions of the recorded audio signal that do not correspond to audio tones used by the one or more libraries.

Embedded content service 209 may determine an identifier of the audio signal and, based on the identifier, retrieve a database linking one or more audio codes to one or more possible device actions. For example, embedded content service 209 may determine that at least a portion of the recorded audio signal corresponds to the identifier provided by content creator device 201 and thus may retrieve the list of registered audio tones from content creator device 201 along with the corresponding audio codes.

In some embodiments, determining the identifier may comprise identifying at least one audio tone in the digital representation and decoding the at least one audio tone to determine the identifier. For example, embedded content service 209 may identify at least one audio tone in the digital representation, e.g., using a brute force search and/or one or more algorithms to calculate similarity between the digital representation and one or more audio tones associated with a list of identifiers, e.g., gathered from content creators that registered audio tones. Accordingly, determining the identifier further may comprise mapping the decoded identifier to an identifier in a list of known identifiers (e.g., an index of identifiers gathered during registration of audio tones). As used herein, “known” may refer to any data stored in an accessible database or hard-corded within a library (e.g., associated with an SDK as explained above).

In some embodiments, determining the identifier may further comprise verifying that the identifier in a list of known identifiers has an associated application identifier that matches an identifier of an application executed by the user device that sent the digital representation. Accordingly, embedded content service 209 may only transmit the API call(s) (as explained below) if the user device (e.g., content consumer device 201) has an application that will respond to the API call(s).

As depicted in FIG. 2, embedded content service 209, content creator device 201, and content consumer device 203 may communicate using one or more computer networks, e.g., network 205. For example, network 205 may comprise the Internet, a local area network (LAN), or the like. Accordingly, embedded content service 209, content creator device 201, and content consumer device 203 may communicate on network 205 using one or more standards, such as WiFi, 4G, long-term evolution (LTE), Ethernet, token ring, or the like.

Embedded content service 209 may thus decode the digital representation to obtain at least one audio code embedded therein. For example, decoding the digital representation may comprise identifying at least one audio tone in the digital representation. In such an example, embedded content service 209 may identify at least one audio tone associated with the determined identifier in the digital representation, e.g., using a brute force search and/or one or more algorithms to calculate similarity between the digital representation and one or more audio tones associated with the determined identifier.

Furthermore, using the retrieved database, embedded content service 209 may map the at least one audio code to one or more device actions. For example, content creator device 201 may have provided the device action(s) when registering the at least one audio code. Accordingly, a content creator device 201 may register a tone that causes a video to be displayed on a user device (or other action as described above), and embedded content service 209 may associate the action(s) with the audio tone such that the action(s) may be retrieved based on the audio tone (and/or associated audio code).

Finally, embedded content service 209 may transmit one or more application programming interface (API) calls to the user device (e.g., content consumer device 203), the one or more API calls corresponding to the one or more device actions, as retrieved from the database. For example, embedded content service 209 may send API calls to a web browser, a multimedia player, or other applications executed on the user device to cause user device to perform the one or more actions.

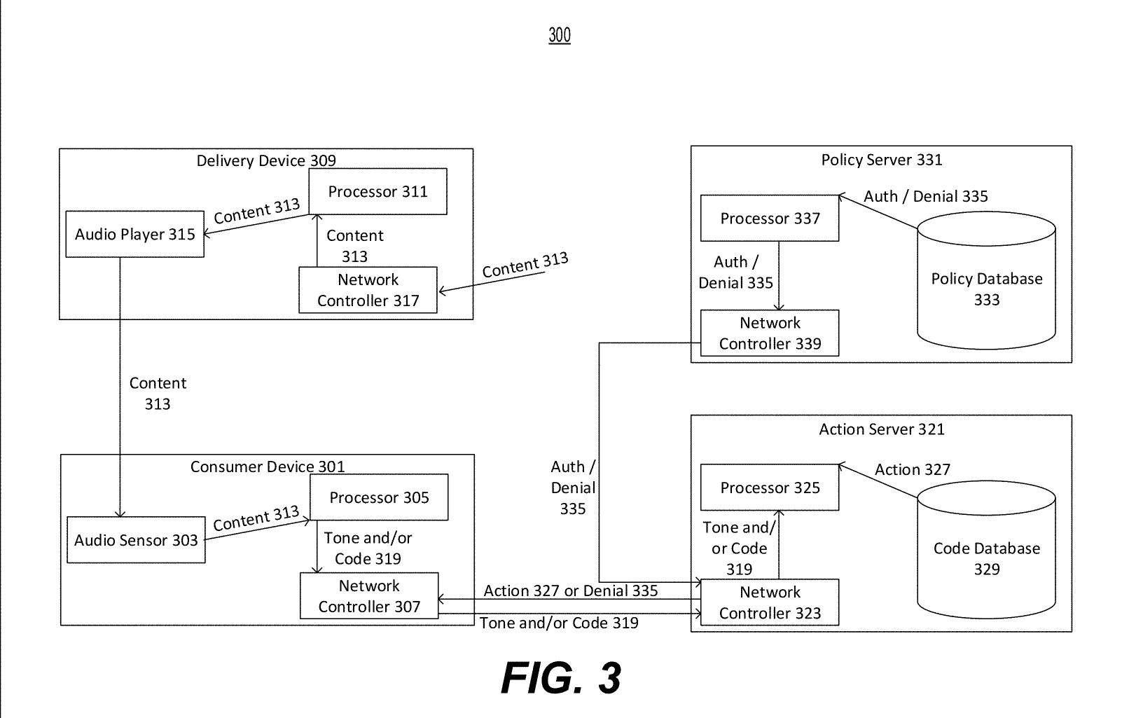

FIG. 3 is a block diagram of an exemplary exchange 300 between a consumer device 301 and a remote sever (e.g., action server 321) for delivery of policy-protected content in response to embedded audio tones. As depicted in FIG. 3, consumer device 301 may comprise a processor 305 that may receive content 313 from audio sensor 303 of consumer device 301. Indeed, in some embodiments, consumer device 301 may comprise a smartphone (e.g., device 1000 of FIGS. 10A and 10B), a tablet, or the like.

Content 313 may have been broadcast by broadcast device 309, e.g., using an audio player 315 (such as one or more speakers). Broadcast device 309 may include a processor 311 for instructing audio player 315. Moreover, broadcast device 309 may retrieve content 313 from a local storage or, as depicted in FIG. 3, from a remote server using network interface controller 317.

In exchange 300, action server 321 (which may comprise one or more servers, e.g., server 900 of FIG. 9) may cooperate with policy server 331 (which may comprise one or more servers, e.g., server 900 of FIG. 9) to receive, from a user device (e.g., consumer device 301), a digital representation of a recorded audio signal (e.g., tone and/or code 319). For example, consumer device 301 may extract tone and/or code 319 from content 313 (e.g., using one or more libraries as described above) for sending, using network interface controller 307, to network interface controller 323 of action server 321. Alternatively, BLAH.

Although not depicted in FIG. 3, action server 321 and/or policy server 331, may further receive, from the user device (e.g., consumer device 301), information associated with the user device. As explained above, action server 321 and/or policy server 331 may decode the digital representation to obtain at least one audio code embedded therein and, using at least one database (e.g., code database 329), mapping the at least one audio code to one or more device actions (e.g., action 327).

Action server 321 and/or policy server 331 may retrieve at least one policy associated with the one or more device actions (e.g., from policy database 333). Action server 321 and/or policy server 331 may verify the received information against the at least one policy such that, when the received information is verified, action server 321 and/or policy server 331 may transmit one or more application programming interface (API) calls (e.g., action 327) to the user device (e.g., consumer device 301), the one or more API calls corresponding to the one or more device actions, and, when the received information is not verified, action server 321 and/or policy server 331 may perform at least one of transmitting a denial message to the user device (e.g., denial 335) or not transmitting the one or more API calls to the user device (e.g., consumer device 301).

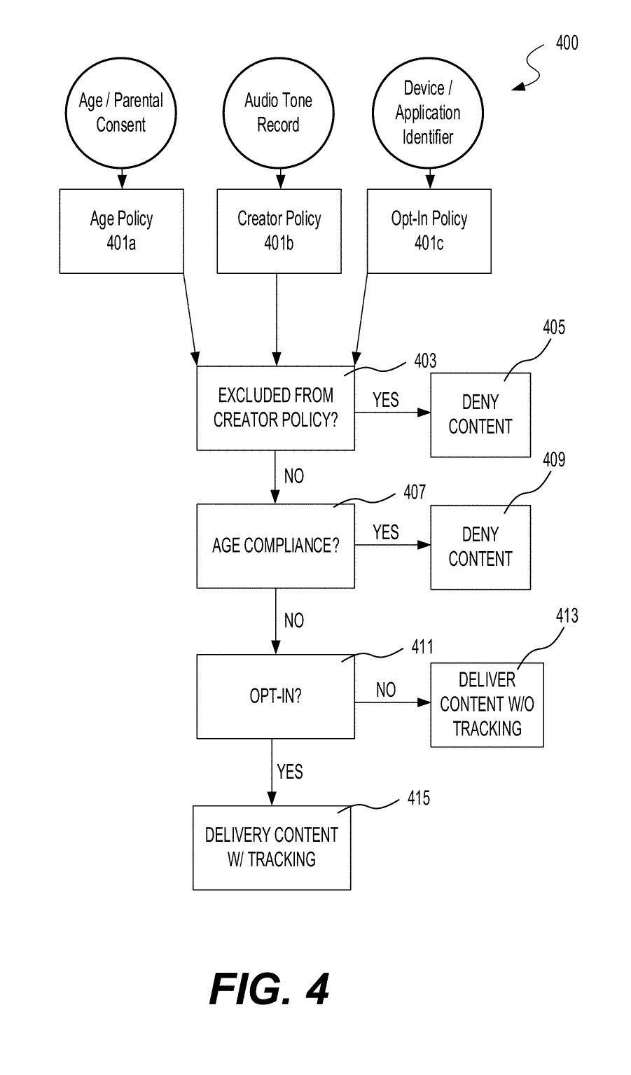

FIG. 4 is a flowchart 400 of exemplary policies used to protect content triggered by embedded audio tones. In the example of FIG. 4, an age policy 401a may restrict delivery based on an age of a user of a consumer device and/or based on parental consent provided to the user of the consumer device. Additionally or alternatively, one or more policies 401b set by content creators may select particular audiences for delivery, such as restricting by demographics (e.g., age, gender, socioeconomic status, residence, or the like), time of day, current location, or the like. Additionally or alternatively, an opt-in (or opt-out) policy 401c may restrict or permit tracking of information associated with the user of the consumer device in addition to the delivery.

At step 403, the policies 401b set by the content creator may be verified such that, at step 405, the delivery is denied if policies 401b are not satisfied, and that, at step 407, process 400 may proceed if policies 401b are satisfied.

At step 407, the age policy 401a may be verified such that, at step 409, the delivery is denied if policy 401a is not satisfied, and that, at step 411, process 400 may proceed if policy 401a is satisfied. Age policy 401a may be set by the content creator in addition to policies 401b and/or may be automatically applied by, e.g., embedded content service 209 of FIG. 2. For example, the content service may automatically apply an age policy to content including nudity, alcohol, tobacco, or the like.

At step 411, the opt-in (or opt-out) policy 410c set by the content consumer may be verified such that, at step 413, the delivery may not include tracking statistics (or other information) related to the user if the user has not opted-in or has opted-out, and that, at step 415, the delivery may include tracking statistics (or other information) related to the user if the user has opted-in or has not opted-out.

The policies of FIG. 4 are exemplary only, and the embodiments of the present disclosure are not limited thereto.

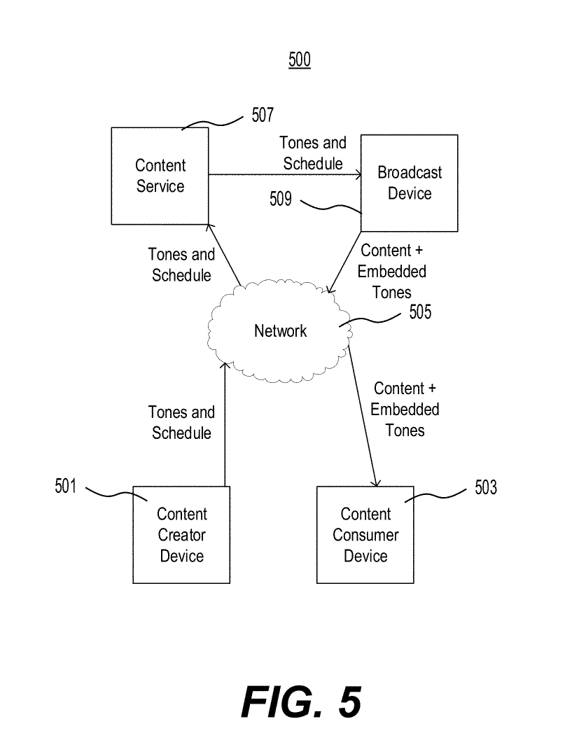

FIG. 5 is a block diagram of an exemplary system 500 for on-demand embedding of audio tones within content. In system 500, a content service 507 (which may comprise one or more servers, e.g., server 900 of FIG. 9) may receive a schedule mapping time stamps of content to one or more audio tones, e.g., from a content creator device 501. Moreover, content service 507 may cooperate with broadcast service 509 to distribute, using at least one of a speaker, a signal transmitter, or a network interface controller, the content, e.g., to content consumer device 503. For example, distributing the content may comprise playing the content such that a consumption device (e.g., content consumer device 503) receives the content using an audio sensor, transmitting the content wirelessly to a playback device (e.g., a television, a radio, or the like) configured to play the content such that a consumption device (e.g., content consumer device 503) receives the content using an audio sensor, and/or transmitting the content over one or more computer networks to a playback device (e.g., a television, a radio, or the like) configured to play the content such that a consumption device (e.g., content consumer device 503) receives the content using an audio sensor

During distribution and at the time stamps, content service 507 may cooperate with broadcast service 509 to embed the one or more audio tones on audio of the content, the one or more audio tones causing a consumption device (e.g., content consumer device 503) to perform one or more actions. Although depicted as stored remotely from broadcast service 509, in other embodiments, the schedule may be stored locally on broadcast service 509.

As depicted in FIG. 2, content service 507, content creator device 501, broadcast service 509, and content consumer device 503 may communicate using one or more computer networks, e.g., network 505. For example, network 505 may comprise the Internet, a local area network (LAN), or the like. Accordingly, content service 507, content creator device 501, broadcast service 509, and content consumer device 503 may communicate on network 505 using one or more standards, such as WiFi, 4G, long-term evolution (LTE), Ethernet, token ring, or the like.

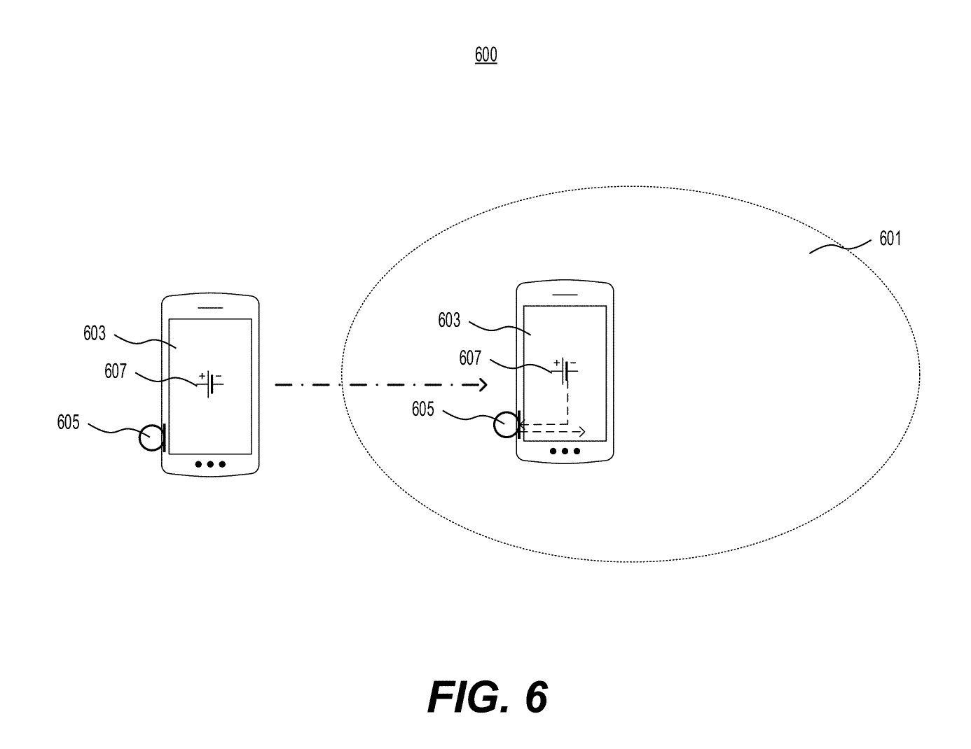

FIG. 6 is a block diagram of an exemplary method 600 of on-demand activation of a microphone 605 of a consumption device 603 using geofencing. In the example of FIG. 6, consumption device 603 may receive a location associated with a user device; transmit the location to a remote server; receive, from the remote server, an indication that the location is within a predefined geographic area (e.g., area 601). Thus, as shown in FIG. 6, in response to the indication, consumption device 603 may activate an audio sensor (e.g., microphone 605) of the user device. Accordingly, consumption device 603 may perform functions of content consumer device 203 of FIG. 2, e.g., receiving, using the audio sensor (e.g., microphone 605) of the user device, a digital representation of an audio signal captured at or near the location; transmit at least a portion of the digital representation to the remote server (not shown); and receive, in response to the transmitted portion, one or more application programming interface (API) calls causing the user device to perform one or more functions.

For example, as depicted in FIG. 6, consumption device 603 may include a battery 607 and/or other power source. As depicted in FIG. 6, activating audio sensor 605 may comprise providing power from battery 607 to the sensor, accepting signals from the sensor for processing, or a combination thereof. In some embodiments, audio sensor 605 may always receive at least some power from battery 607 but may receive less power from battery 607 during deactivation as compared with during activation.

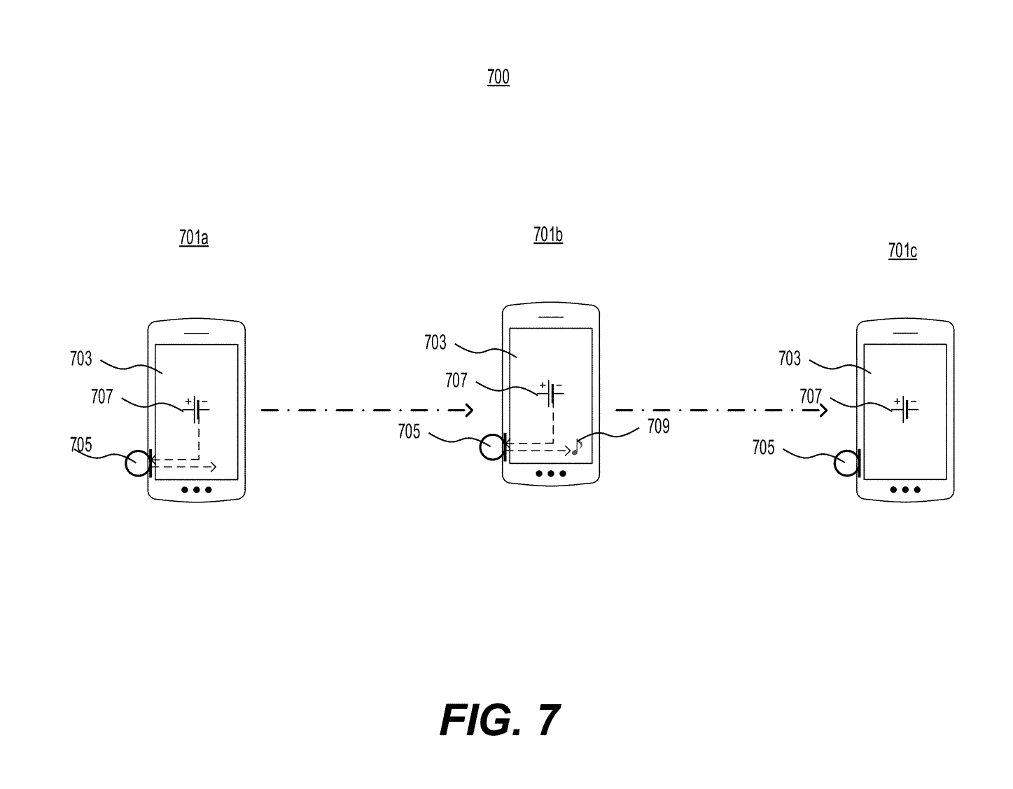

FIG. 7 is a block diagram of an exemplary method 700 of on-demand activation of a microphone 705 of a consumption device 703 using a keep alive audio tone 709. In the example of FIG. 7, consumption device 703 may activate an audio sensor (e.g., microphone 705) of the user device (e.g., step 701a of FIG. 7) and receive, using the audio sensor of the user device, a digital representation of an audio signal 709 (e.g., step 701b of FIG. 7). Consumption device 703 (or a remote sever communicating therewith) may determine whether the digital representation includes at least one audio tone corresponding to a keep alive tone. Accordingly, when the digital representation is determined to include the at least one audio tone, consumption device 703 may maintain the audio sensor (e.g., microphone 705) in the activated state (not shown), and, when the digital representation is determined not to include the at least one audio tone consumption device 703 may deactivate the audio sensor (e.g., microphone 705) of the user device (e.g., step 701c of FIG. 7).

As further depicted in FIG. 7, consumption device 703 may include a battery 707 and/or other power source. As depicted in FIG. 7, activating audio sensor 705 may comprise providing power from battery 707 to the sensor, accepting signals from the sensor for processing, or a combination thereof. In some embodiments, audio sensor 705 may always receive at least some power from battery 707 but may receive less power from battery 707 during deactivation as compared with during activation.

In some embodiments, consumption device 703 (or a remote sever communicating therewith) may determine whether the digital representation includes at least one audio tone corresponding to at least one known audio tone. When the digital representation includes at least one known audio tone, consumption device 703 may transmit the at least one known audio tone to a remote server and receive, in response to the transmitted audio tone, one or more application programming interface (API) calls causing the user device to perform one or more functions. On the other hand, when the digital representation does not include at least one known audio tone, consumption device 703 may determine whether the digital representation includes at least one audio tone corresponding to a keep alive audio tone 709. Accordingly, when the digital representation is determined to include the at least one audio tone, consumption device 703 may maintain the audio sensor (e.g., microphone 705) in the activated state, and, when the digital representation is determined not to include the at least one audio tone consumption device 703 may deactivate the audio sensor (e.g., microphone 705) of the user device. Therefore, consumption device 703 may periodically re-check for a known audio tone or the keep alive audio tone in order to prevent microphone 705 from being continually activated.

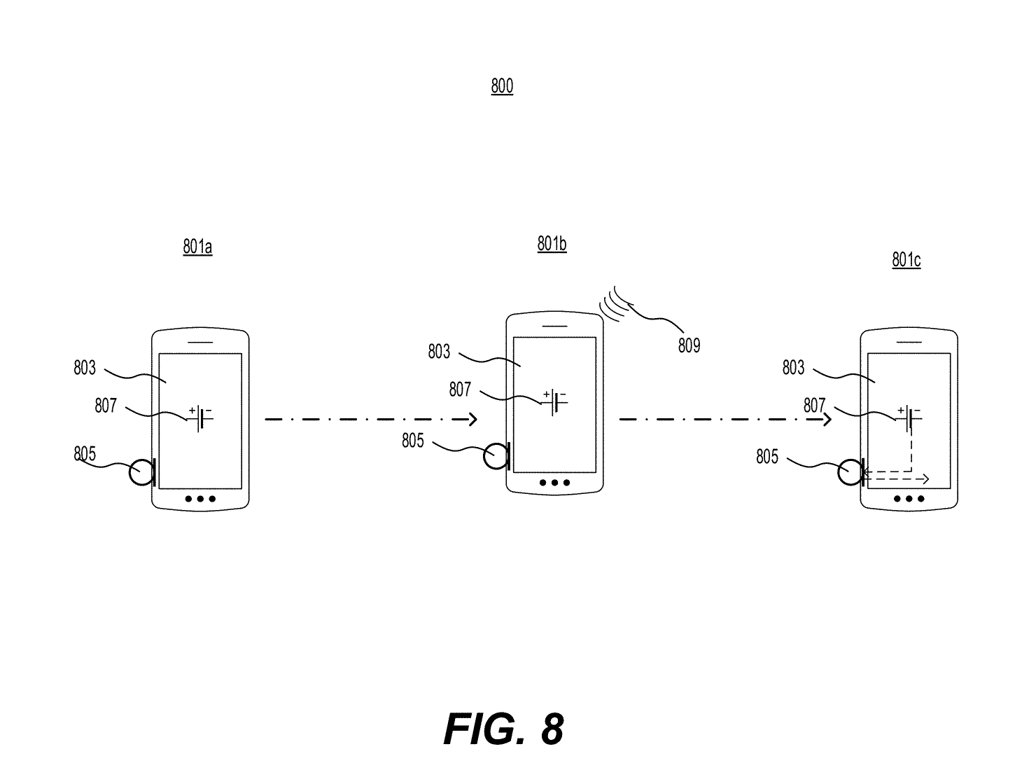

FIG. 8 is a block diagram of an exemplary technique 800 of on-demand activation of a microphone 805 of a consumption device 803 using a networked activation signal 809. In the example of FIG. 8, consumption device 803 may receive a networked signal 809 (e.g., via a wireless network such as a cellular network, a near-field network, or the like using one or more standards, such as Bluetooth®, Bluetooth® Low Energy (BTLE), WiFi, 4G, long-term evolution (LTE), or the like). (e.g., step 801b of FIG. 8) Consumption device 803 (or a remote sever communicating therewith) may determine whether the signal 809 corresponds to an activation signal. Accordingly, when the signal 809 is determined to include the activation signal, consumption device 803 may activate an audio sensor (e.g., microphone 805) (e.g., step 801c of FIG. 8), and, when the signal 809 is determined not to include the activation signal, consumption device 803 may maintain the audio sensor (e.g., microphone 805) of the user device in a deactivated state (not shown).

For example, as depicted in FIG. 8, consumption device 803 may include a battery 807 and/or other power source. As depicted in FIG. 8, activating audio sensor 805 may comprise providing power from battery 807 to the sensor, accepting signals from the sensor for processing, or a combination thereof. In some embodiments, audio sensor 805 may always receive at least some power from battery 807 but may receive less power from battery 807 during deactivation as compared with during activation.

In some embodiments, consumption device 803 (or a remote sever communicating therewith) may determine whether another networked signal includes a keep alive signal. When the other signal includes the keep alive signal, consumption device 803 may maintain the audio sensor (e.g., microphone 805) in the activated state, and, when the other signal is determined not to include the keep alive signal, consumption device 803 may deactivate the audio sensor (e.g., microphone 805) of the user device. Therefore, consumption device 803 may periodically re-check for a keep alive signal in order to prevent microphone 805 from being continually activated.

Although depicted separately, any of the methods of FIGS. 6, 7, and 8 may be combined. For example, a user device may monitor for a keep alive audio tone after a networked signal causes activation the audio sensor. In another example, a user device may monitor for a keep alive audio tone only when within a geofenced area.

FIG. 9 is block diagram of an example device 900 suitable for implementing the disclosed systems and methods. For example, device 900 may comprise a server that performs one or more functions of compliance server 207 and/or embedded content server 209 of FIG. 2, action server 321 and/or policy server 331 of FIG. 3, content server 507 and/or broadcast device 509 of FIG. 5, or the like.

As depicted in FIG. 9, server 900 may have a processor 901. Processor 901 may comprise a single processor or a plurality of processors. For example, processor 901 may comprise a CPU, a GPU, a reconfigurable array (e.g., an FPGA or other ASIC), or the like.

Processor 901 may be in operable connection with a memory 903, an input/output module 905, and a network interface controller (NIC) 907. Memory 903 may comprise a single memory or a plurality of memories. In addition, memory 903 may comprise volatile memory, non-volatile memory, or a combination thereof. As depicted in FIG. 9, memory 903 may store one or more operating systems 909 and program instructions for implementing a content service 911a and/or a policy service 911b. For example, instructions 911a may cause server 900 to function as embedded content server 209 of FIG. 2, action server 321 of FIG. 3, content server 507, or the like. Similarly, instructions 911b may cause server 900 to function as compliance server 207 of FIG. 2, policy server 331 of FIG. 3, broadcast device 509 of FIG. 5, or the like. In addition, memory 903 may store data 913 produced by, associated with, or otherwise unrelated to operating system 909 and/or instructions for implementing content service 911a and/or policy service 911b.

Input/output module 905 may store and retrieve data from one or more databases 915. For example, database(s) 915 may include a database linking one or more audio codes to one or more possible device actions; lists of known audio identifiers, device identifiers, or the like; arrays of known audio tones; or the like.

NIC 907 may connect server 900 to one or more computer networks. In the example of FIG. 9, NIC 907 connects server 900 to the Internet. Server 900 may receive data and instructions over a network using NIC 907 and may transmit data and instructions over a network using NIC 907.

Each of the above identified instructions and applications may correspond to a set of instructions for performing one or more functions described above. These instructions need not be implemented as separate software programs, procedures, or modules. Disclosed memories may include additional instructions or fewer instructions. Functions of server 900 may be implemented in hardware and/or in software, including in one or more signal processing and/or application specific integrated circuits.

FIG. 10A is a depiction of exemplary user device 1000 for use as a contactless device. As depicted in FIG. 10A, device 1000 may comprise a smartphone. Device 1000 may have a screen 1001. For example, screen 1001 may display one or more GUIs that allow a user to enter input activating responses to embedded audio tones and/or providing settings associated therewith, as explained above. In certain aspects, screen 1001 may comprise a touchscreen to facilitate use of the one or more GUIs.

As further depicted in FIG. 10A, device 1000 may have one or more buttons, e.g., buttons 1003a and 1003b. For example, buttons 1003a and 1003b may facilitate use of one or more GUIs displayed on screen 1001.

FIG. 10B is a side view of device 1000 of FIG. 10A. As depicted in FIG. 10B, device 1000 may have at least one processor 1005. For example, at least one processor 1005 may comprise a system-on-a-chip (SOC) adapted for use in a portable device, such as device 1000. Alternatively or concurrently, at least one processor 1005 may comprise any other type(s) of processor.

As further depicted in FIG. 10B, device 1000 may have one or more memories, e.g., memories 1007a and 1007b. In certain aspects, some of the one or more memories, e.g., memory 1007a, may comprise a volatile memory. In such aspects, memory 1007a, for example, may store one or more applications (or “apps”) for execution on at least one processor 1005. For example, an app may include an operating system for device 1000 and/or an app causing device 1000 to perform one or more functions of content consumer device 203 of FIG. 2, consumer device 301 of FIG. 3, content consumer device 503 of FIG. 5, or the like. In addition, memory 1007a may store data generated by, associated with, or otherwise unrelated to an app in memory 1007a.

Alternatively or concurrently, some of the one or more memories, e.g., memory 1007b, may comprise a non-volatile memory. In such aspects, memory 1007b, for example, may store one or more applications (or “apps”) for execution on at least one processor 1005. For example, as discussed above, an app may include an operating system for device 1000 and/or an app for causing device 1000 to perform one or more functions of content consumer device 203 of FIG. 2, consumer device 301 of FIG. 3, content consumer device 503 of FIG. 5, or the like. In addition, memory 1007b may store data generated by, associated with, or otherwise unrelated to an app in memory 1007b. Furthermore, memory 1007b may include a pagefile, swap partition, or other allocation of storage to allow for the use of memory 1007b as a substitute for a volatile memory if, for example, memory 1007a is full or nearing capacity.

As further depicted in FIG. 10B, device 1000 may include at least one network interface controller (NIC) 1009 for connecting device 1000 to one or more computer networks. For example, device 1000 may receive data and instructions over a network using NIC 1009 and may transmit data and instructions over a network using the NIC 1009.

Moreover, device 1000 may include an audio sensor 1011 (such as a microphone) for receiving audio from an environment of device 1000. Microphone 1011 may be activated and deactivated, as described above, and may be used to record audio that includes embedded tones, as described above.

Although depicted as a smart phone, device 1000 may alternatively comprise a tablet or other computing device having similar components.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented with hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive.

Instructions or operational steps stored by a computer-readable medium may be in the form of computer programs, program modules, or codes. As described herein, computer programs, program modules, and code based on the written description of this specification, such as those used by the processor, are readily within the purview of a software developer. The computer programs, program modules, or code can be created using a variety of programming techniques. For example, they can be designed in or by means of Java, C, C++, assembly language, or any such programming languages. One or more of such programs, modules, or code can be integrated into a device system or existing communications software. The programs, modules, or code can also be implemented or replicated as firmware or circuit logic.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A system for providing decoding of audio tones, the system comprising:
at least one memory storing instructions; and
at least one processor configured to execute the instructions to perform operations comprising:
receiving, from a user device, a digital representation of a recorded audio signal;
determining an identifier of the audio signal;
based on the identifier, retrieving a database linking one or more audio codes to one or more possible device actions;
decoding the digital representation to obtain at least one audio code embedded therein;
using the retrieved database, mapping the at least one audio code to one or more device actions; and
transmitting one or more application programming interface (API) calls to the user device, the one or more API calls corresponding to the one or more device actions, as retrieved from the database.

2. The system of claim 1, wherein decoding the digital representation comprises identifying at least one audio tone in the digital representation.

3. The system of claim 2, wherein the at least one audio tone comprises an ultrasonic tone.

4. The system of claim 2, wherein the at least one audio tone comprises an audible tone.

5. The system of claim 2, wherein the at least one audio tone has a gain between 0.1 and 0.5 decibels (dBs).

6. The system of claim 2, wherein the at least one audio tone is embedded within the recorded audio signal using at least one of phase-shift keying (PSK) or frequency-division multiplexing (FDM).

7. The system of claim 6, wherein the at least one audio tone is embedded within the recorded audio signal using at least one of differential phase-shift keying (DPSK) or orthogonal frequency-division multiplexing (OFDM).

8. The system of claim 2, wherein the at least one audio tone is embedded within the recorded audio signal as Morse code.

9. The system of claim 1, wherein determining the identifier comprises identifying at least one audio tone in the digital representation and decoding the at least one audio tone to determine the identifier.

10. The system of claim 9, wherein the at least one audio tone comprises an ultrasonic tone.

11. The system of claim 9, wherein the at least one audio tone comprises an audible tone.

12. The system of claim 9, wherein determining the identifier further comprises mapping the decoded identifier to an identifier in a list of known identifiers.

13. The system of claim 12, wherein determining the identifier further comprises verifying that the identifier in a list of known identifiers has an associated application identifier that matches an identifier of an application executed by the user device that sent the digital representation.

14. The system of claim 1, wherein the one or more device actions comprise at least one of displaying visual content, playing audio content, opening a hyperlink, performing a financial transaction, or transmitting information associated with a user of the user device to a remote server.

15. The system of claim 14, wherein the system comprises the remote server.

16. A system for providing decoding of audio tones, the system comprising:
at least one memory storing instructions; and
at least one processor configured to execute the instructions to perform operations comprising:
receiving, from a user device, a digital representation of a recorded audio signal;
receiving, from a user device, information associated with the user device;
decoding the digital representation to obtain at least one audio code embedded therein;
using at least one database, mapping the at least one audio code to one or more device actions;
retrieving at least one policy associated with the one or more device actions;
verifying the received information against the at least one policy;
when the received information is verified: transmitting one or more application programming interface (API) calls to the user device, the one or more API calls corresponding to the one or more device actions; and
when the received information is not verified: at least one of transmitting a denial message to the user device or not transmitting the one or more API calls.

17. The system of claim 16, wherein the at least one policy comprises a minimum age of a user of the user device.

18. The system of claim 16, wherein the at least one policy is stored on the system based on previous input from the user device.

19. The system of claim 16, wherein the operations further comprise:
transmitting a request to the user device for further information required by the at least one policy; and
receiving, in response to the request and from the user device, the further information,
wherein the one or more API calls are transmitted only when the further information satisfies the at least one policy.

20. The system of claim 19, wherein the further information comprises at least one of a passcode or an age of a user of the user device.

21. A system for providing automatic monitoring for embedded audio tones, the system comprising:
at least one memory storing instructions; and
at least one processor configured to execute the instructions to perform operations comprising:
receiving a location associated with a user device;
transmitting the location to a remote server;
receiving, from the remote server, an indication that the location is within a predefined geographic area;
in response to the indication, activating an audio sensor of the user device;
receiving, using the audio sensor of the user device, a digital representation of an audio signal captured at or near the location;
transmitting at least a portion of the digital representation to the remote server;
receiving, in response to the transmitted portion, one or more application programming interface (API) calls causing the user device to perform one or more functions.

22. The system of claim 21, wherein the operations further comprise:
identifying within the digital representation at least one audio tone embedded therein,
wherein the portion of the digital representation transmitted to the remote service comprises the identified at least one audio tone.

23. The system of claim 21, wherein the operations further comprise:
decoding the digital representation to obtain at least one audio code embedded therein,
wherein the portion of the digital representation transmitted to the remote server comprises the decoded at least one audio code.

24. The system of claim 23, wherein decoding the digital representation comprises applying a library of a software development kit (SDK) to the digital representation.

25. The system of claim 23, wherein decoding the digital representation comprises mapping the portion of the digital representation to the at least one audio code using a database stored locally on the user device.

26. A system for providing on-demand monitoring for embedded audio tones, the system comprising:
at least one memory storing instructions; and
at least one processor configured to execute the instructions to perform operations comprising:
activating an audio sensor of the user device;
receiving, using the audio sensor of the user device, a digital representation of an audio signal;
determining whether the digital representation includes at least one audio tone corresponding to a keep alive tone;
when the digital representation is determined to include the at least one audio tone: maintaining the audio sensor in the activated state; and
when the digital representation is determined not to include the at least one audio tone: deactivating the audio sensor of the user device.

27. The system of claim 26, wherein the operations further comprise receiving the digital representation for a predetermined period of time before determining whether the digital representation includes the at least one audio tone.

28. The system of claim 26, wherein the operations further comprise, after maintaining the audio sensor in the activated state:
determining whether the digital representation includes at least one audio tone corresponding to at least one known audio tone;
when the digital representation includes at least one known audio tone:
transmitting the at least one known audio tone to a remote server, and
receiving, in response to the transmitted audio tone, one or more application programming interface (API) calls causing the user device to perform one or more functions; and
when the digital representation does not include at least one known audio tone:
determining whether the digital representation includes at least one audio tone corresponding to a keep alive audio tone,
when the digital representation is determined to include the at least one audio tone: maintaining the audio sensor in the activated state, and
when the digital representation is determined not to include the at least one audio tone: deactivating the audio sensor of the user device.

29. The system of claim 26, wherein the keep alive tone comprises at least one of an ultrasonic tone and an audible tone.

30. The system of claim 26, wherein the audio sensor comprises a microphone.

31. A system for automatic embedding of audio tones in content, the system comprising:
at least one memory storing instructions; and
at least one processor configured to execute the instructions to perform operations comprising:
receiving a schedule mapping time stamps of content to one or more audio tones;
distributing, using at least one of a speaker, a signal transmitter, or a network interface controller, the content; and
during distribution and at the time stamps, embedding the one or more audio tones on audio of the content, the one or more audio tones causing a consumption device to perform one or more actions.

32. The system of claim 31, wherein the schedule is retrieved from a local storage included in the system.

33. The system of claim 31, wherein the schedule is retrieved from a remote server.

34. The system of claim 31, wherein distributing the content comprises playing the content such that the consumption device receives the content using an audio sensor.

35. The system of claim 31, wherein distributing the content comprises transmitting the content wirelessly to a playback device configured to play the content such that the consumption device receives the content using an audio sensor.

36. The system of claim 31, wherein distributing the content comprises transmitting the content over one or more computer networks to a playback device configured to play the content such that the consumption device receives the content using an audio sensor.
